(19) United States
(12) Patent Application Publication
(10) Pub. No.: US 2014/0325455 A1
(43) Pub. Date: Oct. 30, 2014

(54) VISUAL 3D INTERACTIVE INTERFACE

(71) Applicant: John Patrick Edgar Tobin, San Jose, CA (US)

(72) Inventor: John Patrick Edgar Tobin, San Jose, CA (US)

(73) Assignee: eBay Inc., San Jose, CA (US)

(21) Appl. No.: 13/871,580

(22) Filed: Apr. 26, 2013

(51) Int. Cl. G06F 3/0481

(52) U.S. Cl. CPC G06F 3/04815
USPC 715/850

(57) ABSTRACT

Techniques for generating and displaying a visual three-dimensional (3D) interactive interface are described. According to an exemplary embodiment, a 3D perspective view of a user-selectable user interface element is displayed on display screen of a device. The 3D perspective view of the element may have an apparent position that extends outward from the display screen of the device into a three-dimensional space outside the display screen of the device. Thereafter, a motion detection system may detect a user motion at or proximate to the apparent position of the user interface element in the three-dimensional space outside the display screen of the user device. According to an exemplary embodiment, the detected user motion may be classified as a user selection of the element. According to an exemplary embodiment, an operation associated with the selected element may be performed, in response to the user selection of the element.

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright eBay, Inc. 2013, All Rights Reserved.

### TECHNICAL FIELD

The present application relates generally to data processing systems and, in one specific example, to techniques for generating and displaying a visual three-dimensional (3D) interactive interface.

### BACKGROUND

Various computing devices, such as desktop computers, smart phones, and tablet computers, are configured to display a user-interface on a display screen of the device. Typically, the user interface includes various user-selectable user interface elements, such as buttons, pull-down menus, icons, files, directories, folders, reference links, and so on.

### BRIEF DESCRIPTION OF THE DRAWINGS

Some embodiments are illustrated by way of example and not limitation in the figures of the accompanying drawings in which:

FIG. 1 is a network diagram depicting a client-server system, within which one example embodiment may be deployed;

FIG. 2 is a block diagram of an example system, according to various embodiments;

FIG. 3 is a flowchart illustrating an example method, according to various embodiments;

FIG. 4 illustrates an exemplary portion of a user interface, according to various embodiments;

FIG. 5 illustrates an exemplary portion of a user interface, according to various embodiments;

FIG. 6a illustrates an exemplary portion of a user interface, according to various embodiments;

FIG. 6b illustrates an exemplary overhead view of a device, an apparent position of a user interface element displayed by the device, a hand of a user, and a head position of the user, according to various embodiments;

FIG. 7a illustrates an exemplary portion of a user interface, according to various embodiments;

FIG. 7b illustrates an exemplary overhead view of a device, an apparent position of a user interface element displayed by the device, a hand of a user, and a head position of the user, according to various embodiments;

FIG. 8a illustrates an exemplary portion of a user interface, according to various embodiments;

FIG. 8b illustrates an exemplary overhead view of a device, an apparent position of a user interface element displayed by the device, a hand of a user, and a head position of the user, according to various embodiments;

FIG. 9a illustrates an exemplary portion of a user interface, according to various embodiments;

FIG. 9b illustrates an exemplary overhead view of a device, an apparent position of a user interface element displayed by the device, a hand of a user, and a head position of the user, according to various embodiments;

FIG. 10a illustrates an exemplary portion of a user interface, according to various embodiments;

FIG. 10b illustrates an exemplary overhead view of a device, an apparent position of a user interface element displayed by the device, a hand of a user, and a head position of the user, according to various embodiments;

FIG. 11 is a flowchart illustrating an example method, according to various embodiments;

FIG. 12 illustrates an exemplary portion of a user interface, according to various embodiments;

FIG. 13 illustrates an exemplary portion of a user interface, according to various embodiments;

FIG. 14 illustrates an exemplary overhead view of a device, an apparent position of a user interface element displayed by the device, and a hand of a user, according to various embodiments;

FIG. 15a illustrates an exemplary overhead view of a device, an apparent position of a user interface element displayed by the device, and a hand of a user, according to various embodiments;

FIG. 15b illustrates an exemplary overhead view of a device, an apparent position of a user interface element displayed by the device, and a hand of a user, according to various embodiments;

FIG. 16a illustrates an exemplary overhead view of a device, an apparent position of a user interface element displayed by the device, and a hand of a user, according to various embodiments;

FIG. 16b illustrates an exemplary overhead view of a device, an apparent position of a user interface element displayed by the device, and a hand of a user, according to various embodiments;

FIG. 16c illustrates an exemplary overhead view of a device, an apparent position of a user interface element displayed by the device, and a hand of a user, according to various embodiments;

FIG. 17a illustrates an exemplary overhead view of a device, an apparent position of a user interface element displayed by the device, and a hand of a user, according to various embodiments;

FIG. 17b illustrates an exemplary overhead view of a device and an apparent position of a user interface element displayed by the device, according to various embodiments;

FIG. 17c illustrates an exemplary overhead view of a device, an apparent position of a user interface element displayed by the device, and a hand of a user, according to various embodiments;

FIG. 17d illustrates an exemplary overhead view of a device and an apparent position of a user interface element displayed by the device, according to various embodiments;

FIG. 18 illustrates an exemplary overhead view of a device, an apparent position of a user interface element displayed by the device, and a hand of a user, according to various embodiments;

FIG. 19 is a flowchart illustrating an example method, according to various embodiments;

FIG. 20 illustrates various exemplary devices with sensors for tracking user movements, according to various embodiments;

FIG. 21a illustrates an exemplary portion of a user interface, according to various embodiments;

FIG. 21b illustrates an exemplary portion of a user interface, according to various embodiments;

FIG. 21c illustrates an exemplary portion of a user interface, according to various embodiments;

FIG. 22 is a block diagram illustrating a mobile device, according to exemplary embodiments; and

FIG. 23 is a diagrammatic representation of a machine in the example form of a computer system within which a set of instructions, for causing the machine to perform any one or more of the methodologies discussed herein, may be executed.

### DETAILED DESCRIPTION

Example methods and systems for generating and displaying a visual three-dimensional (3D) interactive interface are described. In the following description, for purposes of explanation, numerous specific details are set forth in order to provide a thorough understanding of example embodiments. It will be evident, however, to one skilled in the art that the present invention may be practiced without these specific details.

Techniques for generating and displaying a visual three-dimensional (3D) interactive interface are described. According to various exemplary embodiments, user interface elements of a user interface may be displayed so that they appear to exist in three dimensions, such that they appear to project outward from a plane of a display screen of a device. The user may then interact with the projected user interface elements, such as by touching (e.g., pressing, swiping, pinching, rotating, etc.) the apparent positions of the projected user interface elements, to thereby perform various operations without ever having to touch the actual display screen of the user device.

According to an exemplary embodiment, a 3D perspective view of a user-selectable user interface element is displayed on display screen of a device. The 3D perspective view of the element may have an apparent position that extends outward from the display screen of the device into a three-dimensional space outside the display screen of the device. Thereafter, a motion detection system may detect a user motion proximate to the apparent position of the user interface element in the three-dimensional space outside the display screen of the user device. Thereafter, the detected user motion may be classified as a user selection of the element. Finally, an operation associated with the selected element may be performed, in response to the user selection of the element.

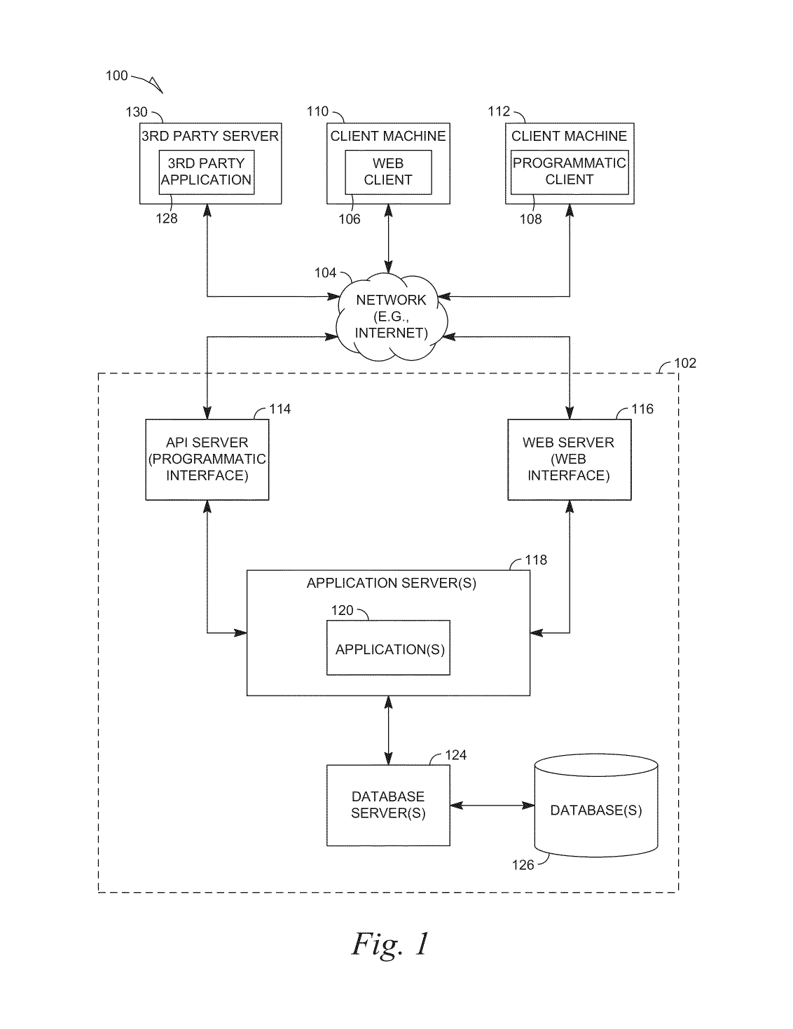

FIG. 1 is a network diagram depicting a client-server system 100, within which one example embodiment may be deployed. A networked system 102 provides server-side functionality via a network 104 (e.g., the Internet or Wide Area Network (WAN)) to one or more clients. FIG. 1 illustrates, for example, a web client 106 (e.g., a browser), and a programmatic client 108 executing on respective client machines 110 and 112.

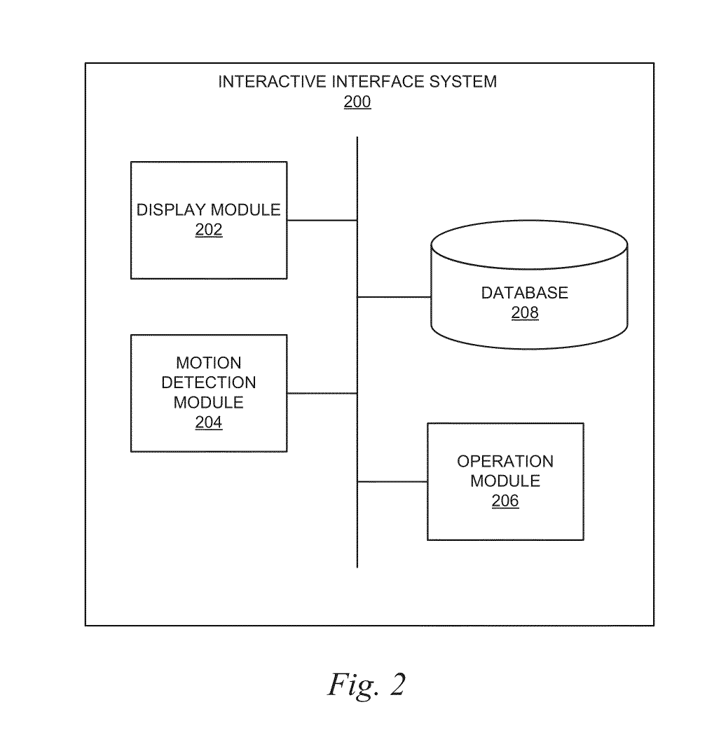

An Application Program Interface (API) server 114 and a web server 116 are coupled to, and provide programmatic and web interfaces respectively to, one or more application servers 118. The application servers 118 host one or more applications 120. The application servers 118 are, in turn, shown to be coupled to one or more databases servers 124 that facilitate access to one or more databases 126. According to various exemplary embodiments, the applications 120 may be implemented on or executed by one or more of the modules of the system 200 illustrated in FIG. 2. While the applications 120 are shown in FIG. 1 to form part of the networked system 102, it will be appreciated that, in alternative embodiments, the applications 120 may form part of a service that is separate and distinct from the networked system 102.

Further, while the system 100 shown in FIG. 1 employs a client-server architecture, the present invention is of course not limited to such an architecture, and could equally well find application in a distributed, or peer-to-peer, architecture system, for example. The various applications 120 could also be implemented as standalone software programs, which do not necessarily have networking capabilities.

The web client 106 accesses the various applications 120 via the web interface supported by the web server 116. Similarly, the programmatic client 108 accesses the various services and functions provided by the applications 120 via the programmatic interface provided by the API server 114.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, thr example, provide one or more functions that are supported by the relevant applications of the networked system 102.

Turning now to FIG. 2, an interactive interface system 200 includes a display module 202, a motion detection module 204, an operation module 206, and a database 208. The modules of the interactive interface system 200 may be implemented on or executed by a single device such as an interactive interface device, or on separate devices interconnected via a network. The aforementioned interactive interface device may be, for example, one of the client machines (e.g. 110, 112) or application server(s) 118 illustrated in FIG. 1.

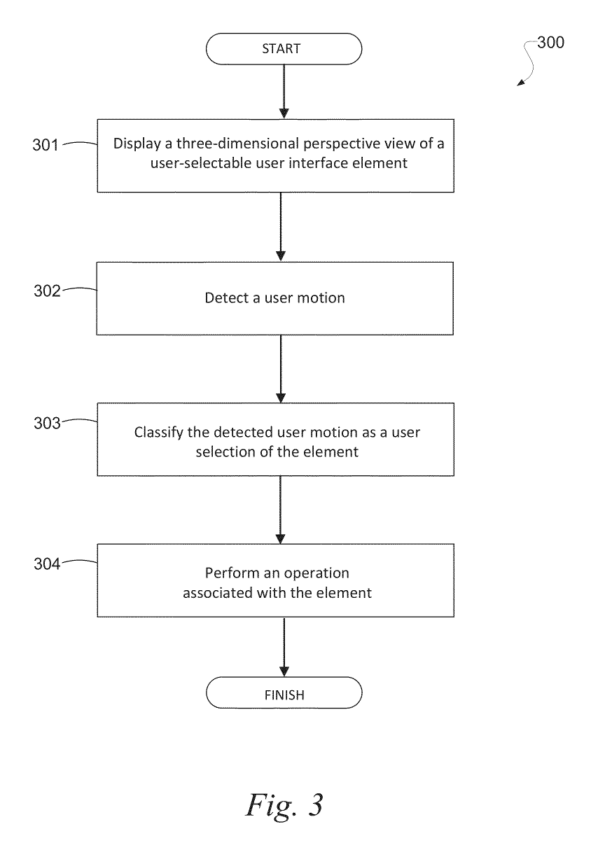

FIG. 3 is a flowchart illustrating an example method 300, according to various exemplary embodiments. The method 300 may be performed at least in part by, for example, the interactive interface system 200 illustrated in FIG. 2 (or an apparatus having similar modules, such as client machines 110 and 112 or application server 118 illustrated in FIG. 1). Operations 301-304 in the method 300 will now be described briefly. In operation 301, the display module 202 displays a three-dimensional (3D) perspective view of a user-selectable user interface element on a display screen of a user device (e.g., a desktop computer, smart phone, tablet computing device, etc.). The 3D perspective view of the element may have an apparent position that extends outward from the display screen of the user device into the three-dimensional space outside (or external to) the display screen of the user device. In operation 302, the motion detection module 204 detects a user motion at or proximate to the three-dimensional space outside (or external to) the display screen of the user device. In operation 303, the operation module 206 classifies the detected user motion as a user selection of the element. Finally, in operation 304, the operation module 206 performs an operation associated with the element, in response to the user selection of the element in operation 303. Each of the aforementioned operations 301-304, and each of the aforementioned modules of the interactive interface system 200, will now be described in greater detail.

Referring back to FIG. 3, in operation 301, the display module 202 displays, on a display screen of a user device, a 3D perspective view of various user-selectable user-interface elements of a user interface. As described throughout, the user device may be one of the client machines 110, 112 or application server 118 illustrated in FIG. 1. The user device may be a smart phone, a desktop computer, a tablet computing device, or any other type of computing device. As described in various embodiments throughout, a 3D perspective view of an object is a graphical representation displayed on a two-dimensional plane/surface, which is constructed to make the object appear to a human observer's eyes as if the object exists in a three-dimensional space. The concept of perspective is well known by those skilled in the graphic arts, where a 3D perspective view is understood to be an approximate representation on a flat surface such as paper or a display screen of a monitor) of an object as it would appear to an observer if the object existed in three-dimensional form. The two most characteristic known features of perspective are (1) that objects are drawn smaller as their distance from an observer increases, and (2) that objects are drawn in a foreshortened state, where the size of an object's dimensions along the line of sight are relatively shorter than dimensions across the line of sight. Other aspects of 3D perspective views of an object are well understood by those skilled the art, and will not be described in more detail in order to avoid occluding various aspects of this disclosure.

Thus, the display module 202 may display a 3D perspective view of the various user selectable user-interface elements of a user interface on a display screen of a user device. In other words, the display module 202 may display two-dimensional (2D) images of the elements on a display screen (e.g., a touchscreen, cathode ray tube (CRT) screen, liquid crystal display (LCD) screen, flat screen, etc.) of the user device, where the 2D images are drawn using a 3D perspective view that causes the elements to appear as if they exist in a three-dimensional space extending outward from the surface of the display screen. According to an exemplary embodiment, the user interface displayed by the display module 202 may be any type of user interface as understood by those skilled in the art, such as a user interface of a software application, browser application, word processing application, an operating system, a gaming application, a mobile application, a device homepage, and so on. According to various exemplary embodiments the various user-selectable user interface elements (e.g., buttons, icons, files, folders, directories, pull-down menus, etc.) of the user interface may be actuated or selected by a user in order to perform some action (e.g., initiating an application program, opening a file folder or directory, specifying a software application command, etc.).

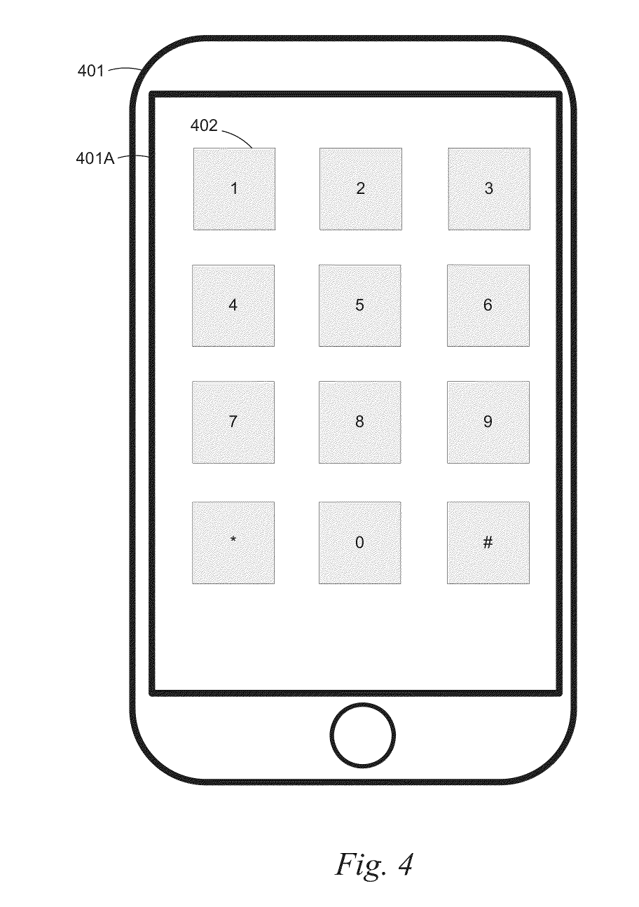

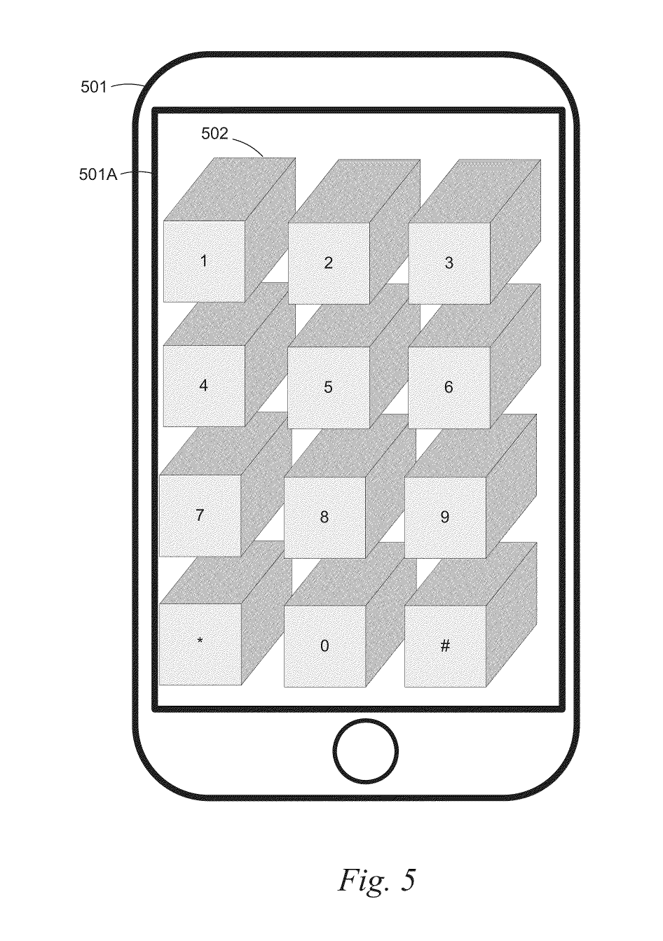

For example, FIG. 4 illustrates a display screen 401A of a user device 401 that displays a user interface including multiple user-selectable buttons (e.g., 402) labelled “1”, “2”, . . . , “#”, etc. As illustrated in FIG. 4, the user-interface elements labelled “1”, “2”, . . . , “#” are 2D images that are displayed in a 2D format. In other words, the user-interface elements “1”, “2”, . . . , “#” do not appear to project front of the display screen 401A. On the other hand, FIG. 5 illustrates a display screen 501A of a device 500 that displays a user interface including multiple user-selectable buttons (e.g., 502) labelled “1”, “2”, . . . , “#”, etc. As illustrated in FIG. 5, the user-interface elements “1”, “2”, . . . , “#” of the user-interface are 2D images that are displayed in a 3D perspective format. In other words, the user-interface elements “1”, “2”, . . . , “#” appear to project beyond the surface of the display screen 501A into the three-dimensional space in front of the display screen 501A. Thus, according to various exemplary embodiments, the 3D view of the user-interface elements causes the user-interface elements to appear as if they exist in three dimensions; i.e., as if they are projecting or extending outward from the surface of the display screen of a device.

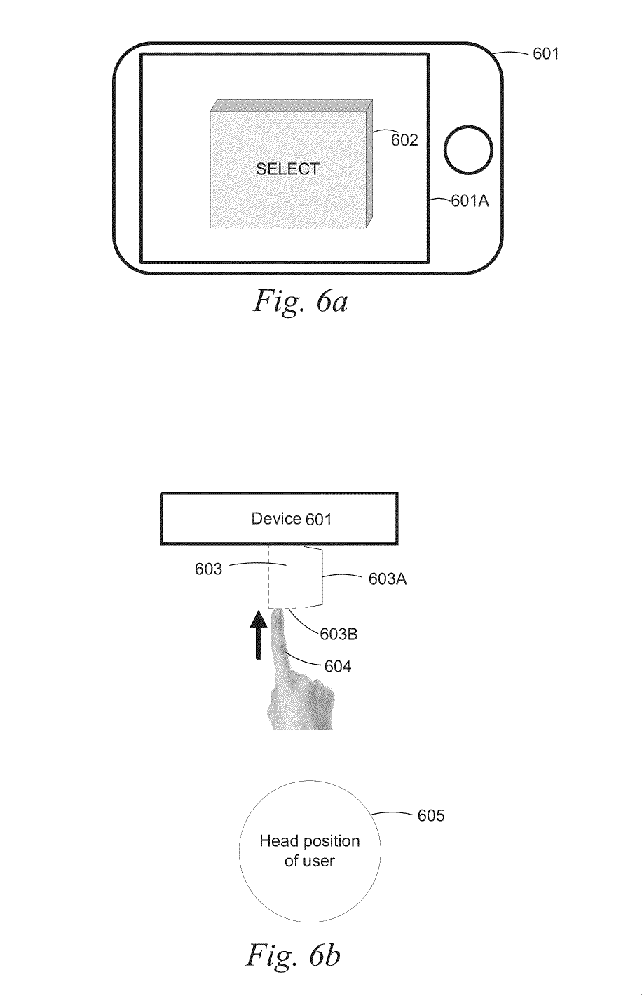

Thus, when a user views the 3D view of the user-interface element, the user perceives the user-interface element as existing in three dimensions, with an apparent position that extends outward from the display screen of the user device into the three-dimensional space in front of display screen of the user device. For example, FIG. 6a illustrates an example of a display screen 601A of a device 601 that is displaying a 3D perspective view of a user-selectable user-interface element (e.g., a button) 602. FIG. 6b illustrates the apparent or perceived position 603 of the button 602, in relation to the device 601 and the head of the user 605, where the user-interface element 602 appears to project beyond the surface of the display screen 601A. More specifically, the button 602 has an apparent position 603 that extends outward from the display screen of the device 601 into the three-dimensional space outside the display screen of the device 601, where 603A in FIG. 6b indicates an apparent height of the element that extends outward from the display screen of the device 601, and 603B in FIG. 6b indicates an apparent upper surface of the element in the three-dimensional space outside of the display screen of the device 601.

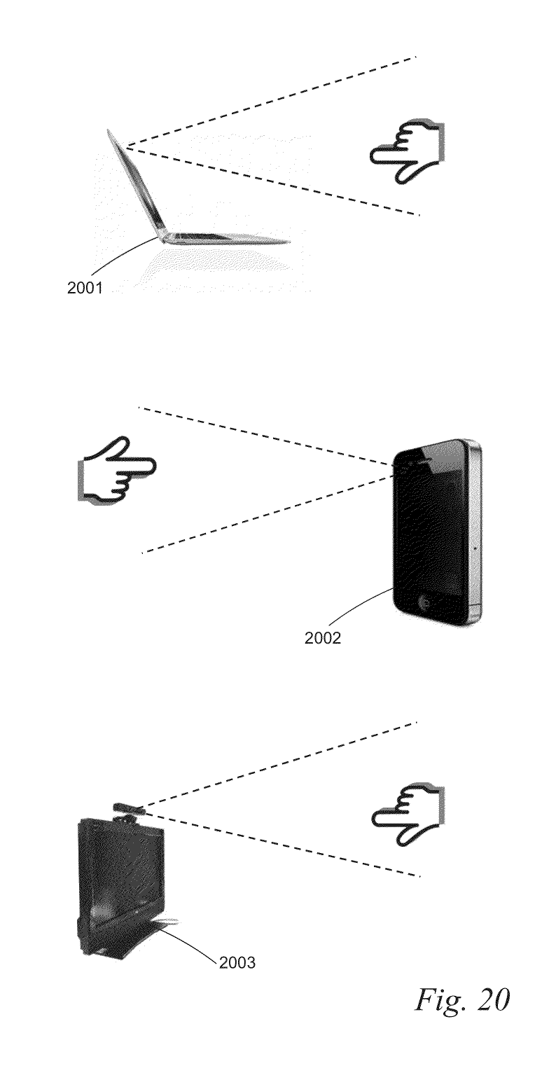

Referring back to the method 300 in FIG. 3, in operation 302, the motion detection module 204 detects a user motion at or proximate to the apparent position of the user-interface element in the three-dimensional space outside the display screen of the user device. For example, as illustrated in FIG. 6b, the motion detection module 204 may detect a movement, motion, or gesture by the user, where a finger 604 of the user makes contact with (or approaches or intersects) the apparent upper surface 603B of the user-interface element 602. According to various exemplary embodiments, the motion detection module 204 may be any type of motion detection system, movement detection system, or gesture recognition system that uses any type of sensor (e.g., infrared, cameras, range finders, etc.) understood by those skilled in the art. Examples of existing motion detection systems include the Kinect™ system offered by Microsoft® and various motion sensor systems offered by Leap Motion, Inc. For example, FIG. 20 illustrates some exemplary devices 2001-2003 having sensors that face a user and that are configured to detect and interpret user interaction with objects that appear to project outward from the display screen of the devices 2001-2003. The user devices displayed in FIG. 20 include a laptop computer 2001 with a forward facing camera, a smart phone 2002 with a forward facing camera, and a television set 2003 with a motion detection system such as the Kinect™ system offered by Microsoft®.

Referring back to the method 300 in FIG. 3, in operation 303, the operation module 206 classifies the user motion that was detected in operation 302 as a user selection of the element. For example, as illustrated in FIGS. 6a and 6b, if the motion detection module 204 detects a user motion where a finger 604 of the user makes contact with (or approaches or intersects) the apparent upper surface 603B of the user-interface element 602, then the operation module 206 may classify this motion as a user selection of the user-interface element 602.

In operation 304 in FIG. 3, the operation module 206 performs an operation associated with the element, in response to the user selection of the element. In some embodiments, the user interface displayed by the display module 202 may be any type of user interface, such as a software application user interface, browser application user interface, document processing application user interface, an operating system user interface, a gaming user interface, a mobile application user interface, a device homepage user interface, and so on. Accordingly, the user-selectable user interface elements may correspond to any element of a user interface that may be selectable by a user. For example, the user selectable user-interface elements may correspond to buttons, icons, files, folders, directories, pull-down menus, text, images, graphics, links, and so on. Thus, when the user actuates or selects the user-interface element in operation 302, the operation module 206 performs an operation (e.g., initiating an application program; opening a file, folder, or directory; specifying a software application command; etc.) associated with the element, in response to the user selection of the user-interface element.

For example, in some embodiments, if the selected element is an icon of a software program or application installed on the user device, then the user selection of this icon in operation 302 may cause the operation module 206 to launch the corresponding application or program associated with the icon. The software program application may be, for example, a web browser program, a document processing program, a game, or any other software application program that may be installed on the user device.

In some embodiments, if the selected element is an icon of a file, directory, or folder installed on the user device, then the user selection of this icon in operation 302 may cause the operation module 206 to open the contents of the corresponding file, directory, or folder. The file may be, for example, a document, picture, video file, animation file, audio file, or any other type of file that may be installed on a user device.

In some embodiments, if the selected element is a command button for performing a function in an application program, then the user selection of this command button in operation 302 may cause the operation module 206 to perform the appropriate command. For example, in a web browser application or document processing application, the command button may correspond to a button in the toolbar of the application (e.g., “file”, “home”, “insert”, “view”, etc.).

In some embodiments, if the selected element is a piece of content such as an alphanumeric character, text, number, image, media item, and so on, the operation module 206 may perform a data operation on the content. For example, if the content is a piece of text or an empty space in a web browser application, document processing application, e-mail application, text message application, etc., then the user selection of the content may cause the operation module 206 to perform a data operation such as a highlight operation, a select operation, a copy operation, a cut operation, a share operation, an upload operation, a delete operation, an operation to open an edit window with multiple options, and so on.

According to various exemplary embodiments described in conjunction with FIG. 6a through FIG. 10b, the 3D perspective view displayed by the display module 202 may be adjusted, based on the relative positions of the display screen of a device and the user, and based on an estimated viewing angle between the user and the display screen of the device. By continually adjusting the 3D perspective view based on an estimated current viewing angle of the user, the user-interface element may appear to the user to exist in three dimensions and have an apparent position extending out from the display screen of the device.

FIG. 6a illustrates an example of a display screen 601A of a device 601 that is displaying a 3D perspective view of a user-selectable user-interface element (e.g., a button) 602. FIG. 6b illustrates an exemplary overhead view of the apparent or perceived position 603 of the button 602, in relation to the device 601 and the head of the user 605, where the user-interface element 602 appears to project beyond the surface of the display screen 601A. More specifically, the button 602 has an apparent position 603 that extends outward from the display screen of the device 601 into the three-dimensional space outside the display screen of the device 601, where 603A in FIG. 6b indicates an apparent height of the element extending outward from the display screen of the device 601, and 603B in FIG. 6b indicates an apparent upper surface of the element in the three-dimensional space outside of the display screen of the device 601.

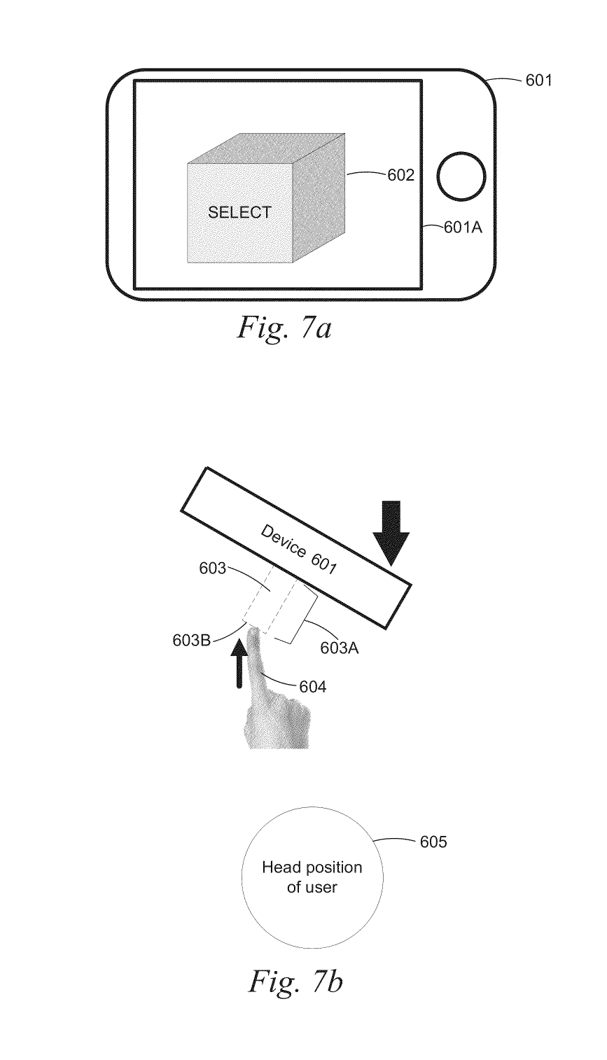

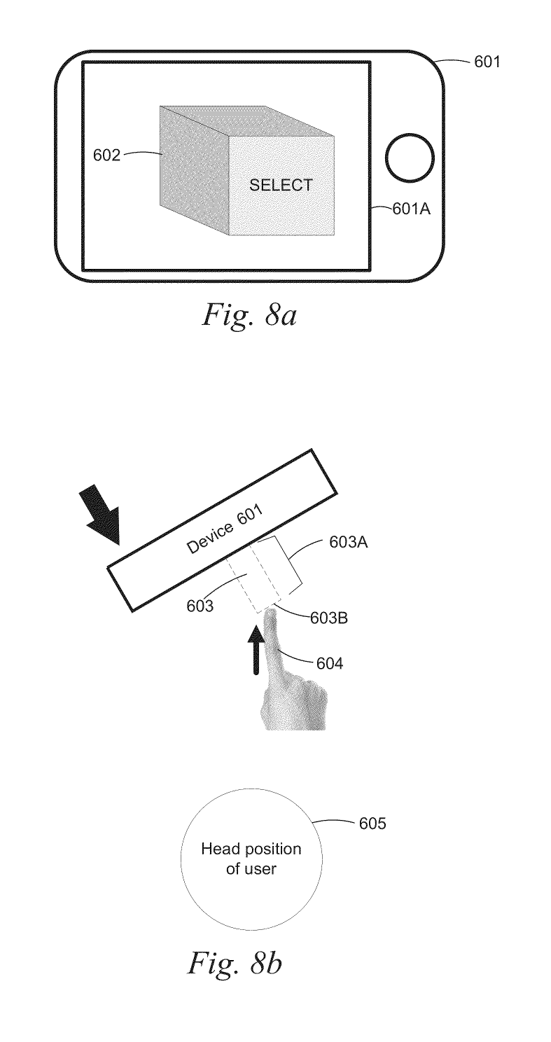

FIGS. 7a and 7b illustrate a scenario where the device 601 has been rotated slightly to the left, in relation to the head position 605 of the user. (Put another way, the device 601 has been rotated around an imaginary vertical axis with respect to the user, so that the right side of the device is closer to the user and the left side of device is farther from the user). Thus, since the head position 605 of the user is to the right of the device 601 in FIG. 7b, the 3D perspective view of the element 602 in FIG. 7a is adjusted so that the element 602 appears to project slightly towards the left side of the display screen 601A from the viewing angle of the head position of the user 605. On the other hand, FIGS. 8a and 8b illustrate a scenario where the device 601 has been rotated slightly to the right, in relation to the head position 605 of the user. (Put another way, the device 601 has been rotated around an imaginary vertical axis with respect to the user, so that the left side of the device is closer to the user and the right side of device is farther from the user). Thus, since the head position of the user 605 is to the left of the device 601 in FIG. 8b, the 3D perspective view of the element 602 in FIG. 8a is adjusted so that the element 602 appears to project slightly towards the right side of the display screen 601A from the viewing angle of the head position of the user 605.

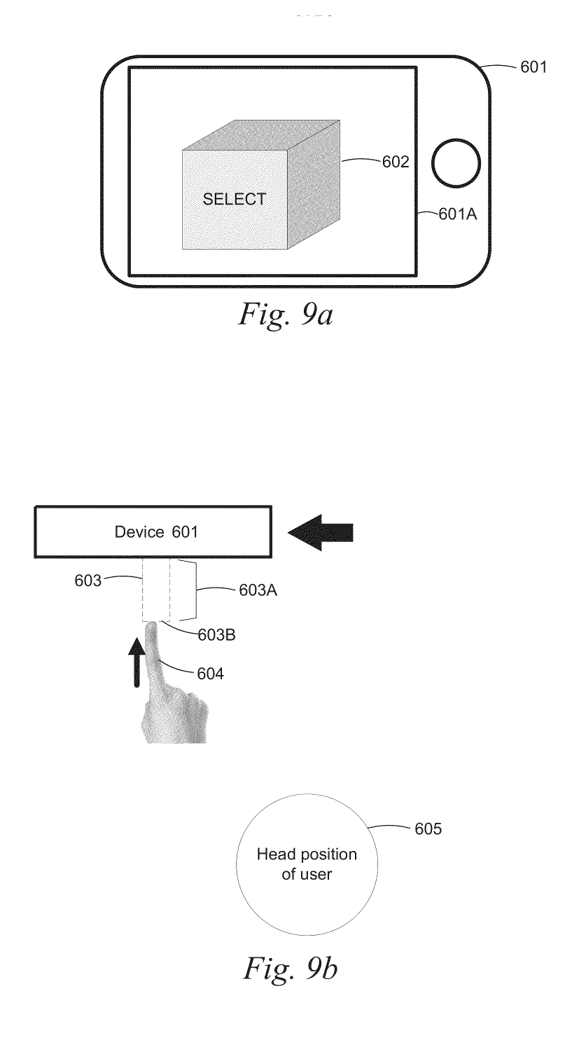

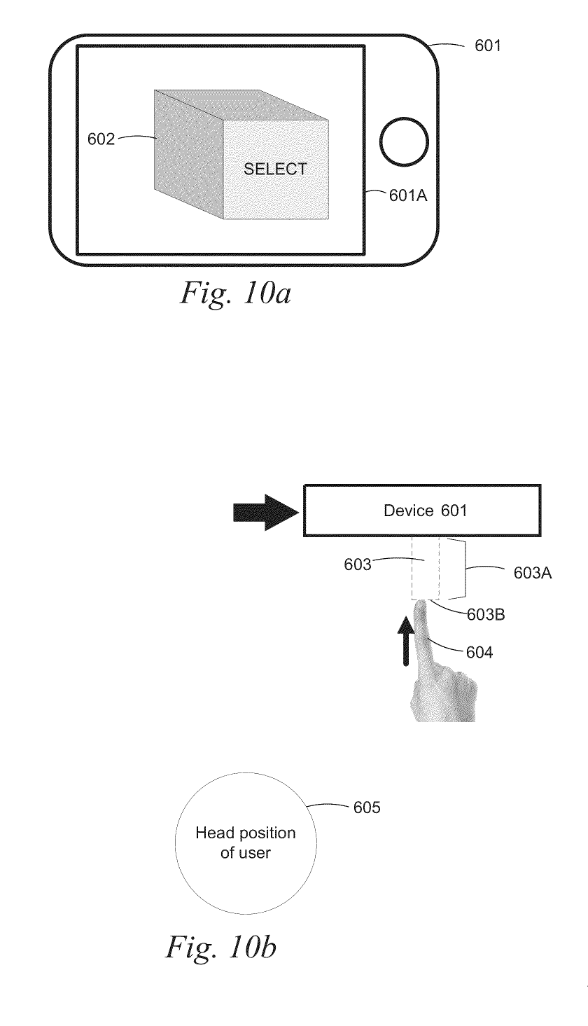

FIGS. 9a and 9b illustrate a scenario where the device 601 has been moved to the left, in relation to the head position 605 of the user. Thus, since the head position of the user 605 is to the right of the device 601 in FIG. 9b, the 3D perspective view of the element 602 in FIG. 9a is adjusted so that the element 602 appears to project slightly towards the left side of the display screen 601A from the viewing angle of the head position of the user 605, thereby exposing more visual detail from the right side of the element 602, FIGS. 10a and 10b illustrate a scenario where the device 601 has been moved to the right, in relation to the head position 605 of the user. Thus, since the head position of the user 605 is to the left of the device 601 in FIG. 10b, the 3D perspective view of the element 602 in FIG. 10a is adjusted so that the element 602 appears to project slightly towards the right side of the display screen 601A from the viewing angle of the head position of the user 605, thereby exposing more visual detail of the left side of the element 602.

According to various exemplary embodiments, the viewing angle of the user may be estimated by the motion detection module 204 by estimating a head position, a hand position, or an eye position of the user. In some embodiments, the motion detection module 204 may estimate the head position of the user using one or more sensors of the user device. For example, a forward-facing camera integrated or attached to a device may be used to track the current position of the head of the user with respect to the device. For example, the mobile application “i3D”, developed by Université Joseph Fourier of Grenoble, France, is an application that utilizes the forward-facing camera of a mobile device to track the head position of a user. In some embodiments, the motion detection module 204 may estimate the eye position of the user by utilizing various eye tracking software applications understood by those skilled in the art, such as eye tracking solutions provided by Tobii Technology of Sweden. In some embodiments, the motion detection module 204 may track the hand position of one or more hands of the user, and estimate the head position and/or viewing angle of the user based on the detected hand positions. According to various exemplary embodiments, the viewing angle of the user may also be estimated by estimating changes in the position of the device. For example, an accelerometer or gyroscope of the device may be utilized to detect when the device is rotated or tilted in various directions (e.g., see FIG. 7b and FIG. 8b), and the display module 202 may adjust the 3D perspective view of a user-interface element accordingly (e.g., see FIG. 7a and FIG. 8a). Applicant has determined that, because the eyes and brain of a human observer are very sophisticated at anticipating and perceiving subtle changes in object positions, if the 3D perspective view of an object is not controlled to accurately match the real-time variations in the orientation of a user device with respect to the user, the brain of the human observer is likely to reject the illusion of the apparent 3-D projection of the object. Thus, according to various exemplary embodiments described herein, small variations in the orientation of a user device with respect to the user, that can occur when the user is holding and viewing the device, may be detected by the interactive interface system 200, and can be used by the display module 202 in controlling the feedback of the projected 3D object to create a better representation of the object's projection. Accordingly the 3-D perspective view of a user-interface element is improved, and the user-interface element is more likely to appear to actually exist in three dimensions.

According to various exemplary embodiments, after the user selects a given user-interface element displayed by the display module 202, the motion detection module 204 is configured to provide feedback indicating that the user has successfully selected the given user-interface element. In some embodiments, when the motion detection module 204 detects that the user has selected a user interface element displayed on the display screen of a user device, the motion detection module 204 may provide haptic feedback or tactile feedback to the user by causing the user device to vibrate. For example, many user devices such as smartphones and cell phones include a vibration mechanism (such as a flywheel motor with an unbalanced or asymmetric weight attached thereto) for causing the device to vibrate, as understood by those skilled in the art. In some embodiments, when the motion detection module 204 detects that the user has selected a user interface element displayed on the display screen of a user device, the motion detection module 204 may cause the user device to emit an audible sound from a speaker of the user device.

In some embodiments, when the motion detection module 204 detects that the user has selected a user interface element displayed on the display screen of a user device, the display module 202 may adjust the display of the 3D perspective view of the element. For example, if the user interface element appears to be a 3D button with an apparent position that extends outwards from the display screen of the user device (e.g., see 602 in FIG. 6a), then the display module 202 may cause the apparent position of the user interface element to be modified. For example, the display module 202 may adjust the 3D perspective view of the selected user interface element to reduce the apparent height of the element and/or indicate that the user interface element has been pressed down towards the plane of the display screen. Thus, the display module 202 may redraw the selected user interface element (e.g., showing perturbation or deformation of the apparent surfaces of the user-interface element), to represent interpreted user object manipulation and/or to represent external pressure on the user-interface element (e.g., based on the user selection of the user interface element).

In some embodiments, the motion detection module 204 may change other visual aspects (e.g., colors, shading, border, outlines, etc.) of any component of the user interface that is being displayed on the display screen of the user device.

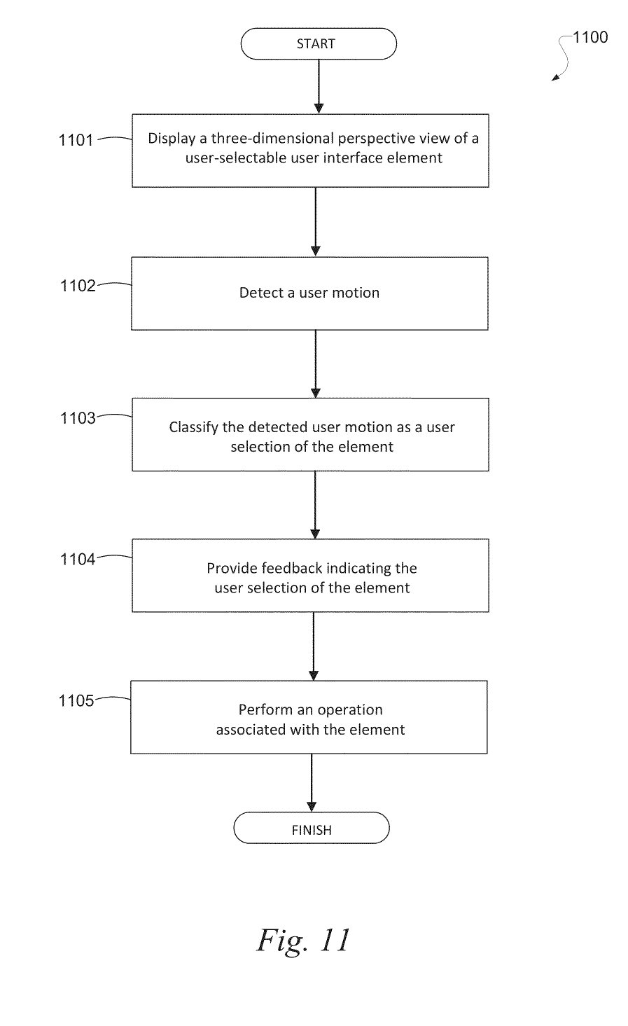

FIG. 11 is a flowchart illustrating an example method 1100, consistent with various embodiments described above. The method 1100 may be performed at least in part by, for example, the interactive interface system 200 illustrated in FIG. 2 (or an apparatus having similar modules, such as client machines 110 and 112 or application server 118 illustrated in FIG. 1). Operations 1101-1103 are similar to operations 301-303 in the method 300 of FIG. 1 operation 1104, the display module 202 or motion detection module 204 provides feedback indicating that the user has successfully selected a given user-interface element, in response to the selection of the user interface element in operation 1102 and/or 1103. For example, the display module 202 or motion detection module 204 may cause the user device to vibrate, or may cause the user device to emit an audible sound from a speaker of the user device, or may adjust the display of the 3D perspective view of the selected user interface element. Operation 1105 is similar to operation 304 in the method 300 of FIG. 3.

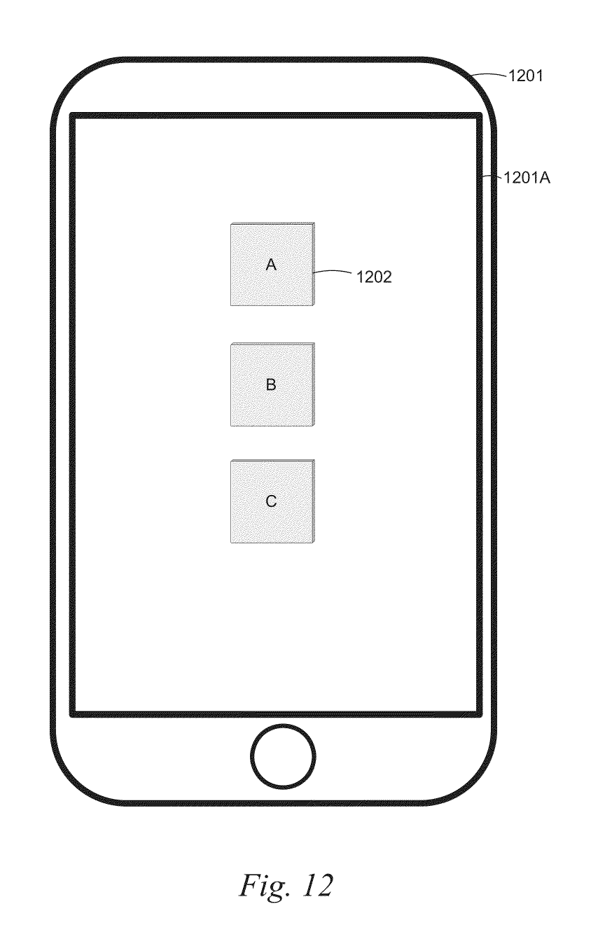

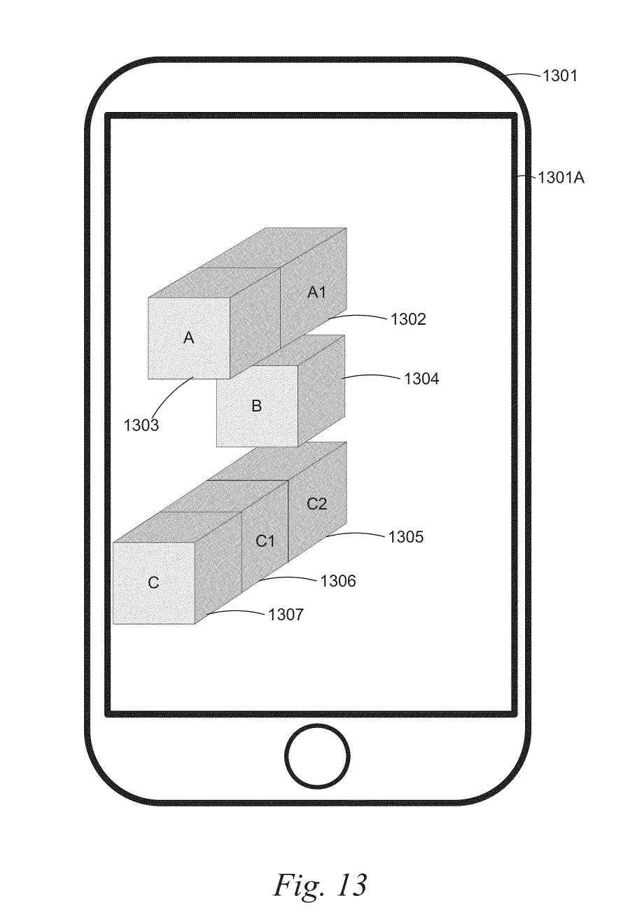

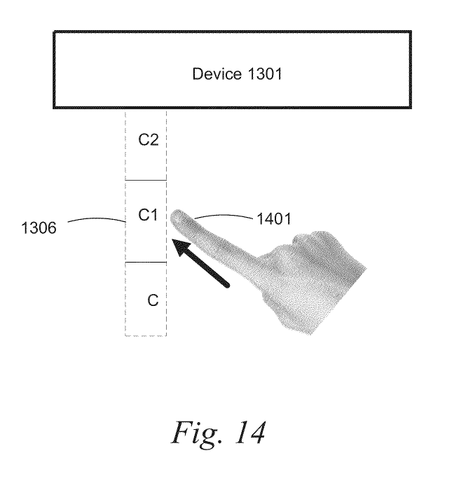

According to various exemplary embodiments, the 3D perspective view of a user interface element displayed by the display module 202 many reveal various sub portions of the user-interface element that are not visible from a conventional 2D view of the user-interface element. For example, FIG. 12 illustrates a display screen 1201A of a device 1201 that displays a conventional 2D view of three user-interface elements (e.g., 1202) labeled “A”, “B”, and “C”. In comparison, FIG. 13 illustrates a display screen 1301A of a device 1301 that displays a 3D perspective view of three user-interface elements labeled “A”, “B”, and “C”, where the 3D perspective view of the user-interface elements reveals various adjacent sub portions of these elements along a height axis of the elements that extends outward from the plane of the display screen 1301A of the user device. For example, the 3D perspective view of the user-interface element labeled “A” (1303) reveals a sub-portion labeled “A1” (1302) of the element 1303. Similarly, the 3D perspective view of the user-interface element labeled “C” (1307) reveals sub-portions labeled “C1” (1306) and “C2” (1305) of the element 1303. Each of the sub-portions C, C1, and C2 may actually correspond to different user selectable elements. In other words, if the motion detection module 204 detects that the user has selected the element C (1307), the operation module 206 will perform one operation, whereas if the motion detection module 204 detects that the user has selected the element C1 (1306), the operation module 206 will perform a different operation, and if the motion detection module 204 detects that the user has selected the element C2 (1305), the operation module 206 will perform yet another different operation. FIG. 14 illustrates a case where a hand 1401 of the user selects the element C1 (1306). Thus, consistent with various embodiments described herein, the functionality of a user-interface displayed by a device may be considerably improved, in comparison to conventional user interfaces.

According to various exemplary embodiments, the user selection of the user interface element in operation 302 in the method of FIG. 3 may correspond to a pressing motion or gesture. For example, as illustrated in FIG. 6b, the user may “press” a user interface element 602 by placing a finger 604 (or another object, such as a pen or stylus) on the apparent upper surface 603B of the user interface element 602 and pushing the finger 604 towards the display screen 601A of the device 601. According to various exemplary embodiments, user selections having other types of motions or gestures may be detected by the motion detection module 204. In some embodiments, the type of the gesture involved in the user selection of a given element may control the type of operation performed by the operation module 206. In other words, the operation module 206 may perform one of many operations when a user selects a particular user interface element, depending on the way the user selects the particular user interface element.

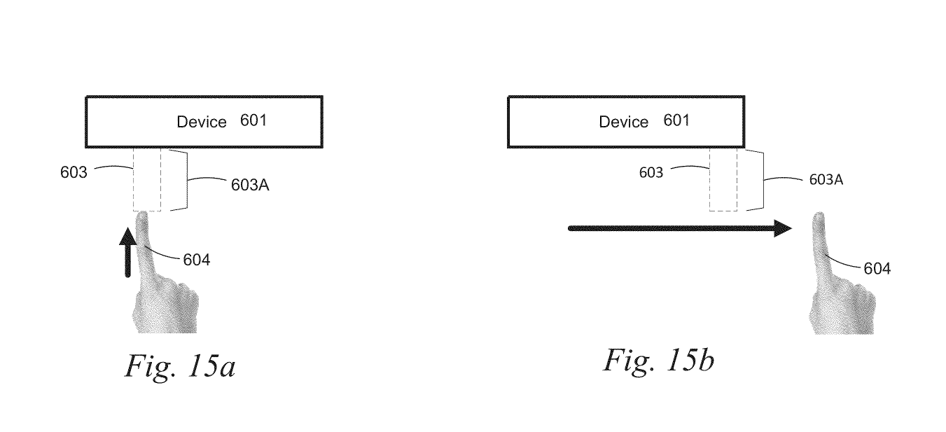

For example, in some embodiments, the user selection may correspond to a swiping motion, where the user presses the apparent upper surface of a user interface element with a finger and then moves, slides, or swipes the finger in a particular direction. For example, FIG. 15a illustrates a situation where user presses with a finger 604 on the apparent upper surface of the apparent position 603 of the user-interface element displayed on the display surface of the device 601. Further, FIG. 15b illustrates a subsequent situation where the user swipes the finger 604 to the right and away from the display screen of the device 601. As illustrated in FIG. 15b, the display of the apparent position 603 of the user-interface element may be adjusted so that the element also slides to the right portion of the display screen of the device 601. In some embodiments, if the motion detection module 204 detects a swipe gesture, the operation module 206 may perform a swipe-to-unlock function. For example, the user may select a swipe button and then swipe in a particular direction in order to unlock a device and access the functionalities of the device. In some embodiments, if the motion detection module 204 detects a swipe gesture, the operation module 206 may scroll through displayed content. For example, the user may select a selection button of a scroll bar and then slide up, down, left, or right in order to scroll through displayed content (e.g., a document or webpage) in a particular direction.

According to various exemplary embodiments, the motion detection module 204 may detect a swiping motion by determining that the finger 604 of the user has pressed the apparent upper surface of a user-interface element (e.g., see FIG. 15a), and is moving the finger at greater than a predetermined velocity or acceleration (e.g., see FIG. 15b). In such case, the motion detection module 204 may cause the selected element to continue to move at a specific velocity or acceleration across the display screen, even if the user removes their finger from the apparent upper surface of the user-interface element. In other words, the swiping motion may also give the object 602 an apparent “momentum” or “inertia” that will allow the object to travel across the screen without need for the user to swipe the complete distance.

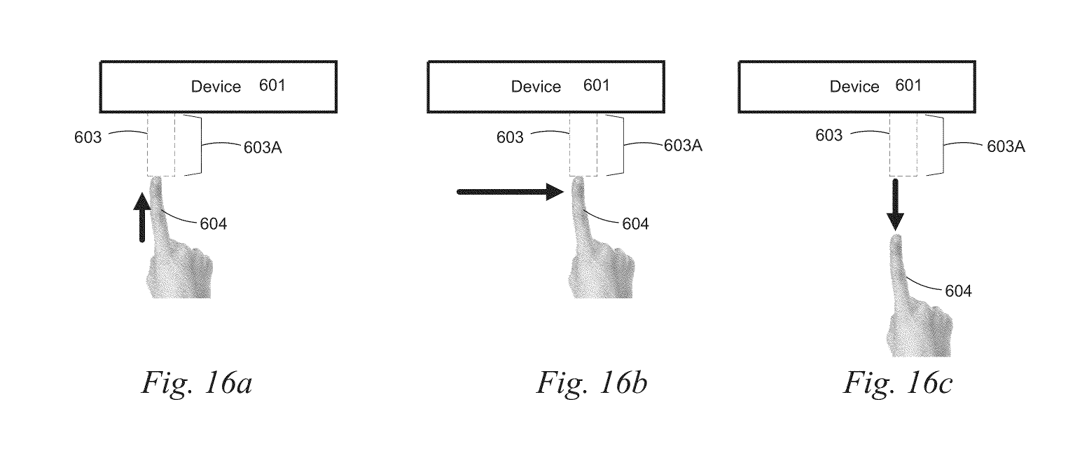

In some embodiments, the user selection may correspond to a drag-and-drop motion, where the user presses the apparent upper surface of a user interface element with a finger and then moves the finger towards another space in front of the user interface, and then releases the finger from the apparent upper surface of the user interface element. For example, FIG. 16a illustrates a situation where a user presses with a finger 604 on the apparent upper surface of the apparent position 603 of the user-interface element displayed on the display surface of the device 601. As described elsewhere in various embodiments throughout, pressing on the apparent upper surface of the user-interface element may result in the perturbation or deformation of the apparent surfaces of the user-interface element to signal to the user that the object has been selected. Further, FIG. 16b illustrates a subsequent situation thereafter where the user moves the finger 604 to the right side of the display screen of the device 601. As illustrated in FIG. 16b, the display of the apparent position 603 of the user-interface element may be adjusted so that the element also slides to the right portion of the display screen of the device 601. FIG. 16c illustrates a subsequent situation thereafter where the user moves the finger 604 away from the apparent upper surface of the apparent position 603 of the user-interface element displayed on the display surface of the device 601. In some embodiments, if the motion detection module 204 detects this gesture, the operation module 206 may perform a drag-and-drop operation in order to move application icons from one position on the user interface to another position on the user interface. In some embodiments, if the motion detection module 204 detects this drag-and-drop gesture, the operation module 206 may perform a drag and drop operation to move files, folders or directories stored in one location to another location.

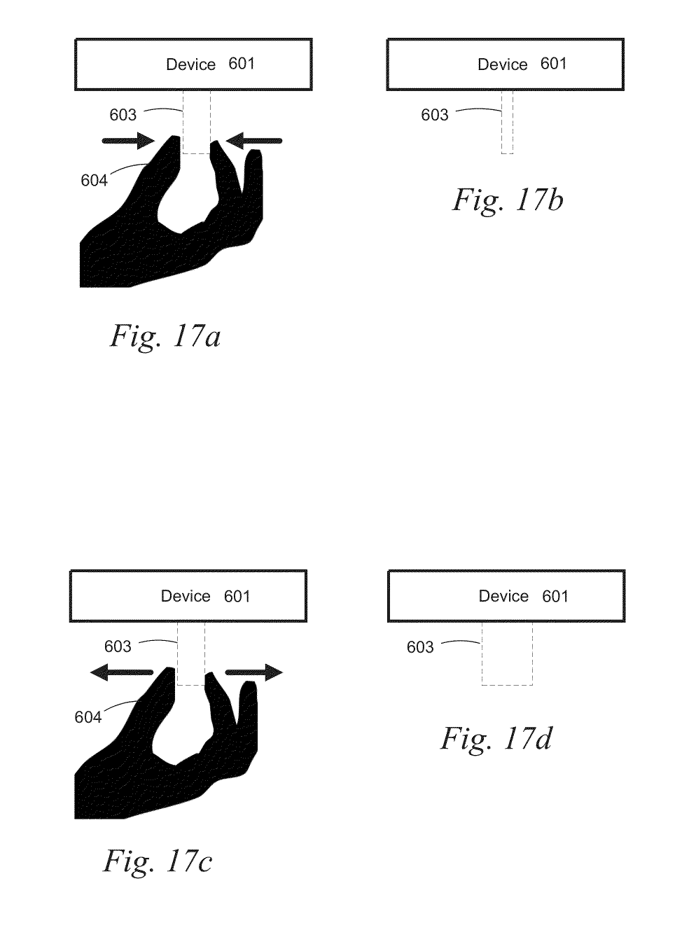

In some embodiments, the user selection may correspond to a pinching motion, where the user grasps the two or more apparent sides of the user interface element with two or more fingers. The user may then press inward with the fingers (e.g., move the fingers closer towards each other) in order to pinch or “squeeze” on the apparent sides of the user interface element. For example, FIG. 17a illustrates a situation where the user presses with fingers 604 on the apparent sides of the apparent position 603 of the user-interface element displayed on the display surface of the device 601. In some embodiments, if the motion detection module 204 detects a pinching gesture, the operation module 206 may reduce the size of the user interface element (e.g., to represent the “pinching” of the user interface element), as illustrated in FIG. 17b. In some embodiments, if the motion detection module 204 detects a pinching gesture, the operation module 206 may zoom out on the displayed user interface.

In some embodiments, the user selection may correspond to a reverse-pinching motion, where the user grasps the two or more apparent sides of the user interface element with two or more fingers. The user may then pull outward with the fingers (e.g., move the fingers away from each other). For example, FIG. 17b illustrates a situation where the user presses with fingers 604 on the apparent sides of the apparent position 603 of the user-interface element displayed on the display surface of the device 601, and then moves the fingers away from the apparent position 603 of the user-interface element. In some embodiments, if the motion detection module 204 detects this reverse-pinching gesture, the operation module 206 may expand the size of the user interface element (e.g., to represent the “expanding” of the user interface element), as illustrated in FIG. 17d. In some embodiments, if the motion detection module 204 detects this reverse-pinching gesture, the operation module 206 may zoom in on the displayed user interface.

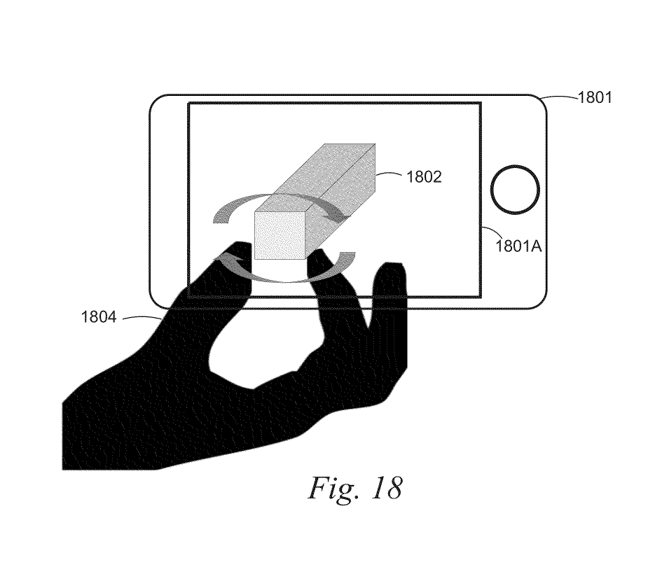

In some embodiments, the user selection may correspond to a rotating motion, where the user grasps the two or more apparent sides of the user interface element with two or more fingers. The user may then rotate their hand and/or fingers in a particular direction (e.g., clockwise or counter-clockwise). For example, FIG. 18 illustrates a situation where the user presses with fingers 1804 on the apparent sides of the user-interface element 1802 displayed on the display surface 1801A of the device 1801, and then rotates their hand and/or fingers in a clockwise direction. In some embodiments, if the motion detection module 204 detects a rotation gesture, the operation module 206 may rotate the selected user interface element, or rotate other elements of a user interface displayed on the display screen of the user device, or rotate the entire user interface displayed on the display screen of the user device.

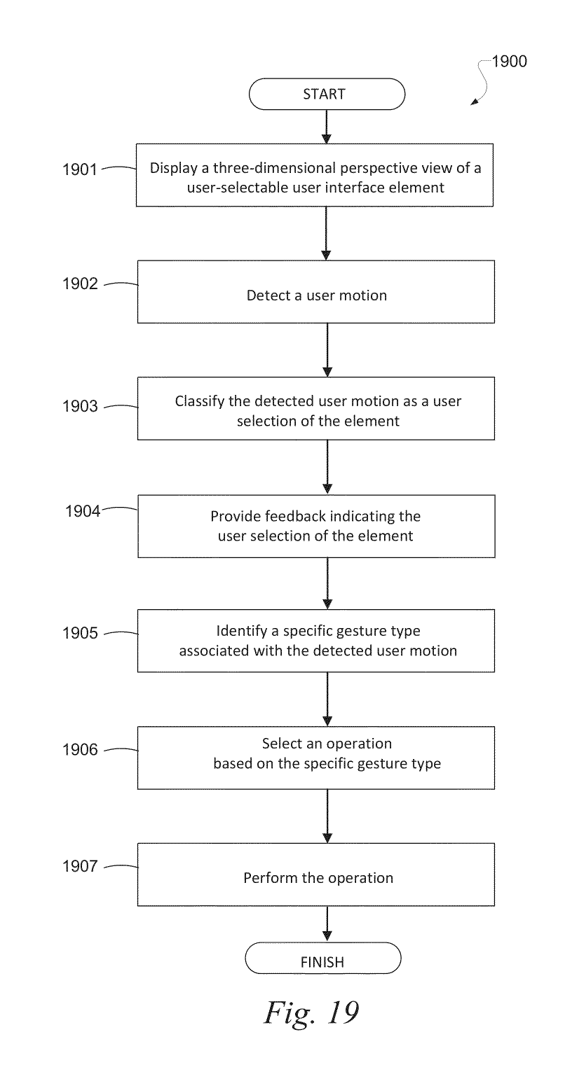

FIG. 19 is a flowchart illustrating an example method 1900, consistent with various embodiments described above. The method 1900 may be performed at least in part by, for example, the interactive interface system 200 illustrated in FIG. 2 (or an apparatus having similar modules, such as client machines 110 and 112 or application server 118 illustrated in FIG. 1). Operations 1901-1903 are similar to operations 301-303 in the method 300 of FIG. 3. In operation 1904, the display module 202 or motion detection module 204 provides feedback indicating that the user has successfully selected a given user-interface element, in response to the selection of the user interface element in operation 1902 and/or 1903. For example, the display module 202 or motion detection module 204 may cause the user device to vibrate, or may cause the user device to emit an audible sound from a speaker of the user device. As another example, the display module 202 may adjust the display of the 3D perspective view of the selected user interface element. For example, the display module 202 may redraw the selected user interface element (e.g., showing perturbation or deformation of the apparent surfaces of the user-interface element), to represent interpreted user object manipulation and/or to represent external pressure on the user-interface element (e.g., based on the user selection of the user interface element).

In operation 1905, the motion detection module 204 identifies a specific gesture type associated with the user motion that was detected in operation 1902. For example, the operation module 206 may identify the specific gesture type from among a plurality of predefined gesture types including a pressing motion, a swiping motion, a pinching motion, a reverse pinch motion, a rotating motion, a drag-and-drop motion, and so on. In operation 1906, the operation module 206 selects an operation from among a plurality of predefined operations, based on the specific gesture type identified in operation 1905. For example, if the gesture type identified in operation 1905 is a pressing motion, then the operation module 206 may open a file associated with the user selected element. On the other hand, if the gesture type identified in operation 1905 is a drag-and-drop motion, then the operation module 206 may move the file from its present storage location to a new storage location corresponding to where the user “dropped” the file via the drag-and-drop motion. In operation 1907, the operation module 206 performs the operation selected in operation 1906. For example, the operation module 206 may open a file associated with the user selected element, or move the file from its present storage location to a new storage location, etc.

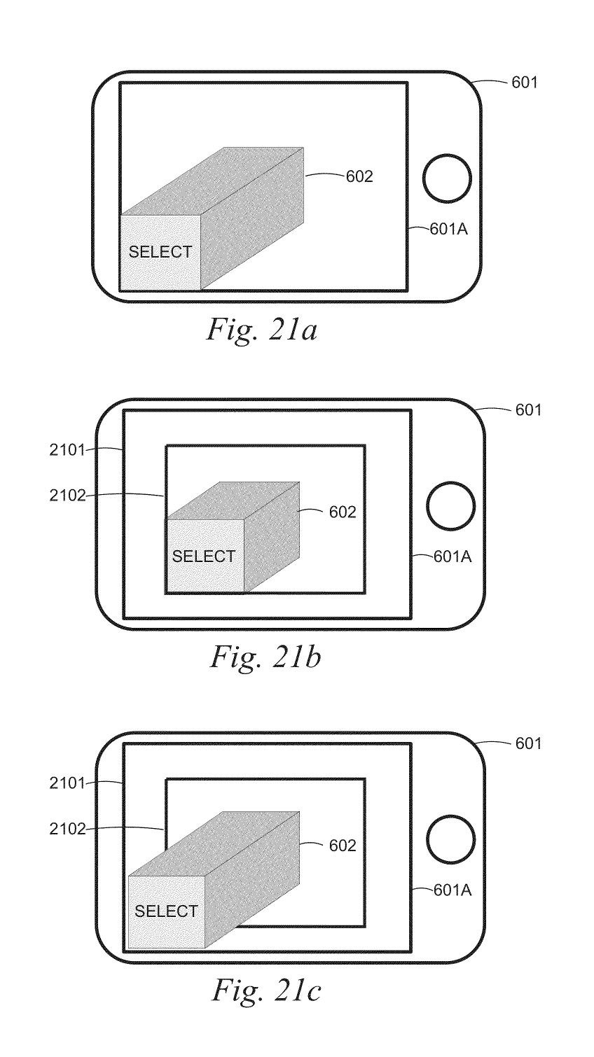

According to various exemplary embodiments, the realism of the 3-D perspective view of a user interface element may be improved, by generating the illusion that the 3-D perspective view of the user-interface element can extend beyond the actual boundary of the display screen. For example, as illustrated in FIGS. 6a through 10b, the 3-D perspective view of the user-interface element 602 is adjusted based on movement of the user device 601 with respect to the head position of the user 605. However, there may be a scenario where changes in the position of the device or the user may cause the displayed object to be “clipped” at the edge of the display screen, and thereby degrade the experience. For example, FIG. 21a illustrates a display screen 601A of the user device 601 that displays a 3-D perspective view of the user-interface element 602. As illustrated in FIG. 21a, the user-interface element 602 is at the actual boundary 2101 of the display screen 601A, cannot be extended any further towards the lower left corner of the display screen 601A.

Thus, according to various exemplary embodiments, the display module 202 is configured to display a “false edge” or “false boundary” of the display screen that is configured to look like the actual boundary of the display screen to a human observer, but that is smaller than the actual boundary of the display screen. For example, FIG. 21b illustrates the actual boundary 2101 of the display screen 601A of the user device 601, as well as a false boundary 2102 displayed by the display module 202. As illustrated in FIG. 21b, the 3-D perspective view of the user-interface element 602 has been extended to the edge of false boundary 2102, such that the element 602 appears to be at the edge of the display screen of the device 601, and appears as if it is about to be clipped by the edge of the display screen. In reality, the element 602 can be extended even further past the false boundary 2102 and up to the actual boundary 2101, as illustrated in FIG. 21c. This tool may be particularly effective because in many devices (including mobile devices), the actual edges of the display screen are flush with the case of the mobile device, so that the partition between the actual boundary of the display screen and the adjoining frame is sometimes difficult to discern (especially if the display screen and the frame of the user device have a similar color, such as black). According to various exemplary embodiments, a light sensor of the user device may be configured to determine current light conditions, and dynamically select the color of the drawn border between the false boundary 2102 and the actual boundary 2101 (e.g., varying shades of reflective black/gray), in order to simulate the color of the frame of the device outside the actual boundary 2101, in order to make the false boundary 2102 appear as if it is the actual boundary of the user device.

Various embodiments described throughout our applicable to any type of device, including a mobile device (e.g., a smart phone, a cell phone, a tablet computing device, a laptop computer, notebook computer, etc.), as well as stationary devices and desktop computers, personal computers, workstations, servers, and so on. An exemplary mobile device will now be described below.

### Example Mobile Device

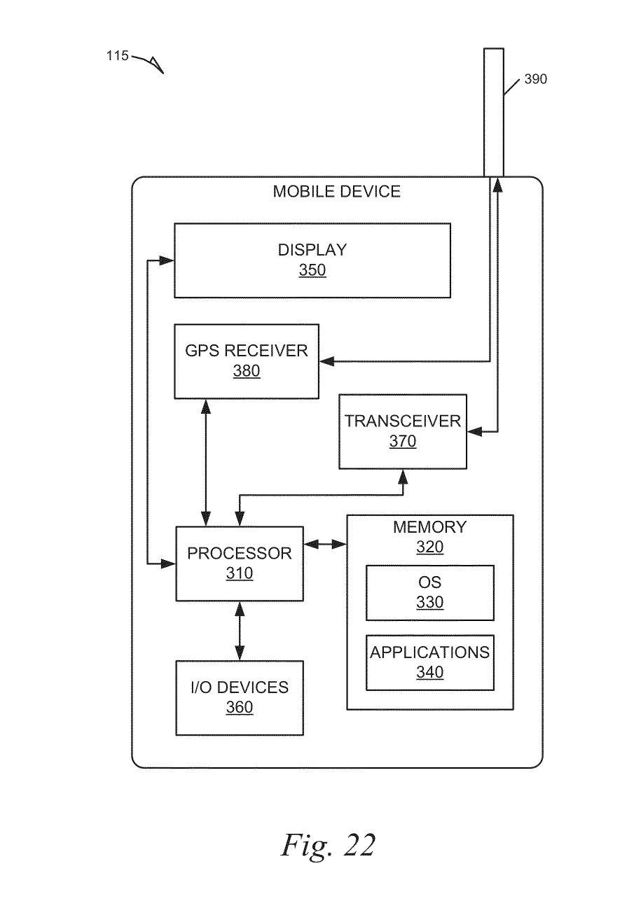

FIG. 22 is a block diagram illustrating a mobile device 115 (which may correspond to or be implemented by the client machines 110, 112 illustrated in FIG. 1), according to an example embodiment. The mobile device 115 may include a processor 310. The processor 310 may be any of a variety of different types of commercially available processors suitable for mobile devices for example, an XScale architecture microprocessor, a Microprocessor without interlocked Pipeline Stages (MIPS) architecture processor, or another type of processor). A memory 320, such as a Random Access Memory (RAM), a Flash memory, or other type of memory, is typically accessible to the processor 310. The memory 320 may be adapted to store an operating system (OS) 330, as well as application programs 340, such as a mobile-location-enabled application that may provide location-based services (LBSes) to a user. The processor 310 may be coupled, either directly or via appropriate intermediary hardware, to a display 350 and to one or more input/output (I/O) devices 360, such as a keypad, a touch panel sensor, a microphone, and the like. Similarly, in some embodiments, the processor 310 may be coupled to a transceiver 370 that interfaces with an antenna 390. The transceiver 370 may be configured to both transmit and receive cellular network signals, wireless data signals, or other types of signals via the antenna 390, depending on the nature of the mobile device 115. Further, in some configurations, a GPS receiver 380 may also make use of the antenna 390 to receive GPS signals.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them, Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network,

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

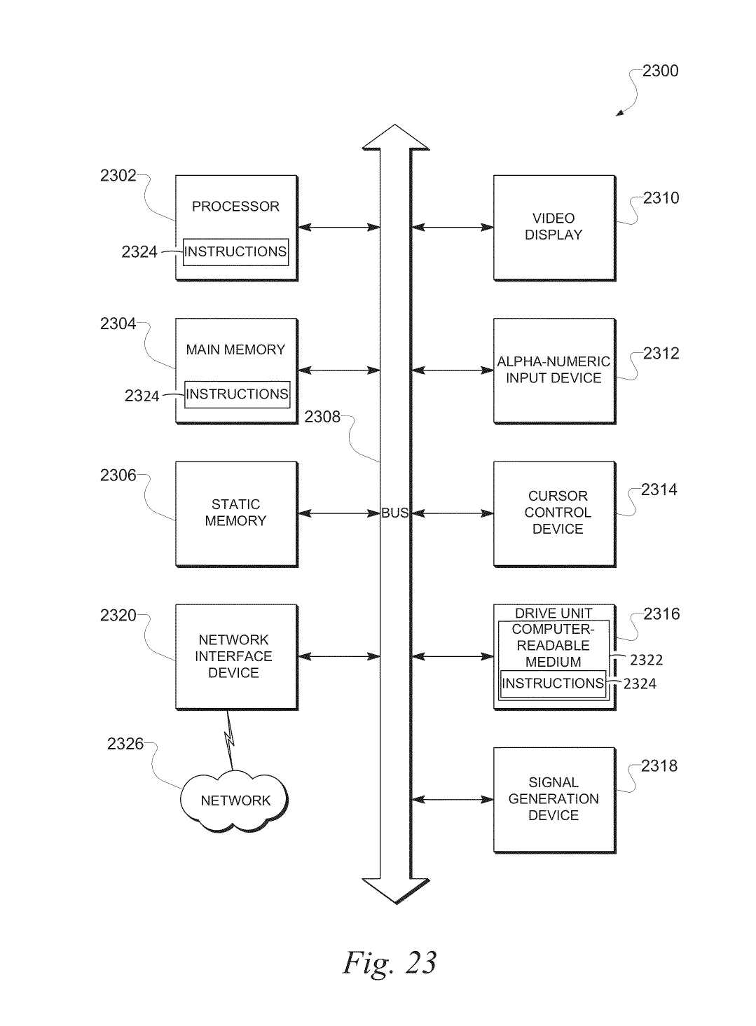

FIG. 23 is a block diagram of machine in the example form of a computer system 2300 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 2300 includes a processor 2302 (e.g., a central processing unit (CPU), a graphics processing unit (GPU) or both), a main memory 2304 and a static memory 2306, which communicate with each other via a bus 2308. The computer system 2300 may further include a video display unit 2310 (e.g., a liquid crystal display (LCD) or a cathode ray tube (CRT)). The computer system 2300 also includes an alphanumeric input device 2312 (e.g., a keyboard or a touch-sensitive display screen), a user interface (UI) navigation device 2314 (e.g., a mouse), a disk drive unit 2316, a signal generation device 2318 (e.g., a speaker) and a network interface device 2320.

### Machine-Readable Medium

The disk drive unit 2316 includes a machine-readable medium 2322 on which is stored one or more sets of instructions and data structures (e.g., software) 2324 embodying or utilized by any one or more of the methodologies or functions described herein. The instructions 2324 may also reside, completely or at least partially, within the main memory 2304 and/or within the processor 2302 during execution thereof by the computer system 2300, the main memory 2304 and the processor 2302 also constituting machine-readable media.

While the machine-readable medium 2322 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks,

### Transmission Medium

The instructions 2324 may further be transmitted or received over a communications network 2326 using a transmission medium. The instructions 2324 may be transmitted using the network interface device 2320 and any one of a number of well-known transfer protocols (e.g., HTTP). Examples of communication networks include a local area network. (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method comprising:
displaying, via a display screen of a user device, a three-dimensional perspective view of a user-selectable user interface element, the three-dimensional perspective view of the element having an apparent position that extends outward from the display screen of the user device into a three-dimensional space external to the display screen of the user device;
detecting, using a motion detection system, a user motion at or proximate to the apparent position of the user interface element in the three-dimensional space external to the display screen of the user device;
classifying the detected user motion as a user selection of the element; and
performing an operation associated with the element, in response to the user selection of the element.

2. The method of claim 1, wherein the performing comprises:
executing a data operation on data associated with the selected element, wherein the element corresponds to one or more alphanumeric characters or an image.

3. The method of claim 1. wherein the performing comprises:
launching an application or program associated with the selected element, wherein the element corresponds to any one of an application icon or a program icon.

4. The method of claim 1, wherein the performing comprises:
accessing any one of a file, a directory, and a folder associated with the element, where the element corresponds to any one of a file icon, a directory icon, and a folder icon.

5. The method of claim 1, wherein the performing further comprises:
executing a software application function associated with the element, wherein the element corresponds to a software application function command button.

6. The method of claim 1, further comprising:
identifying, from among a plurality of predefined gesture types, a specific gesture type associated with the detected user motion.

7. The method of claim 6, wherein the plurality of predefined gesture types include a pressing motion, a swiping motion, a pinching motion, a reverse pinch motion, a rotating motion, and a drag-and-drop motion.

8. The method of claim 6, further comprising:
selecting the operation from among a plurality of pre-defined operations, based on the specific gesture type.

9. The method of claim 1, further comprising:
adjusting the display of the three-dimensional perspective view of the element, in response to the user-selection of the element.

10. The method of claim 1, further comprising:
emitting an audible sound from a speaker of the user device, in response to the user-selection of the element.

11. The method of claim 1, further comprising:
causing the user device to vibrate, in response to the user-selection of the element.

12. The method of claim 1, wherein the displaying further comprises:
estimating a head position of the user in relation to a position of the user device; and
adjusting the display of the three-dimensional perspective view of the element, based on the estimated head position of the user.

13. The method of claim 1, wherein the displaying further comprises:
estimating, using an eye tracking system, an eye position of a user in relation to a position of the user device; and
adjusting the display of the three-dimensional perspective view of the element, based on the estimated eye position of the user.

14. The method of claim 1, wherein the displaying further comprises:
detecting, using an accelerometer or a gyroscope of the user device, movement in a position of the user device; and
adjusting the display of the three-dimensional perspective view of the element, based on the detected movement of the user device.

15. The method of claim 1, wherein the three-dimensional perspective view of the element includes multiple adjacent sub-portions of the element along a height axis of the element that extends outward from the display screen of the device, each of the adjacent sub-portions corresponding to a different user-selectable user interface element.

16. The method of claim 15, further comprising:
detecting, using the motion detection system, a user motion proximate to the an apparent position of a specific sub-portion of the user-selectable element;
classifying the detected user motion as a user selection of the specific sub-portion of the element; and
performing an operation associated with the specific sub-portion of the element.

17. The method of claim 1, wherein the user motion does not include user contact with the display screen.

18. An apparatus comprising:
a display module configured to display, via a display screen of a user device, a three-dimensional perspective view of a user-selectable user interface element, the three-dimensional perspective view of the element having an apparent position that extends outward from the display screen of the user device into a three-dimensional space external to the display screen of the user device;
a motion detection module configured to detect a user motion at or proximate to the apparent position of the user interface element in the three-dimensional space external to the display screen of the user device; and
an operation module configured to:
classify the detected user motion as a user selection of the element; and
perform an operation associated with the element, in response to the user selection of the element.

19. The apparatus of claim 18, wherein the operation module is further configured to:
launch an application or program associated with the selected element, wherein the element corresponds to any one of an application icon or a program icon.

20. A non-transitory machine-readable storage medium having embodied thereon instructions executable by one or more machines to perform operations comprising:
displaying, via a display screen of a user device, a three-dimensional perspective view of a user-selectable user interface element, the three-dimensional perspective view of the element having an apparent position that extends outward from the display screen of the user device into a three-dimensional space external to the display screen of the user device;
detecting, using a motion detection system, a user motion at or proximate to the apparent position of the user interface element in the three-dimensional space external to the display screen of the user device;
classifying the detected user motion as a user selection of the element; and
performing an operation associated with the element, in response to the user selection of the element.
